(19) United States
(12) Patent Application Publication
(10) Pub. No.: US 2007/0126889 A1
(43) Pub. Date: Jun. 7, 2007

(54) Method and apparatus of creating and displaying a thumbnail

(75) Inventor: Nam-Jin Kim, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/607,351

(22) Filed: Dec. 1, 2006

(30) Foreign Application Priority Data
Dec. 1, 2005 (KR) 2005-0116133

(51) Int. Cl. H04N 5/225; H04N 5/76; H04M 1/00

(52) U.S. Cl. 348/231.2; 348/207.99; 455/556.1

(57) ABSTRACT

A method of creating a thumbnail using luminance of a video sequence includes grouping the video sequence into predetermined frame groups and extracting basic frames of the groups; calculating a luminance difference between the extracted basic frames using the extracted basic frames; selecting motion prediction pixel frames using the calculated luminance differences between the basic frames; and calculating standard deviations of the selected motion prediction pixel frames and selecting a predetermined number of frames having great standard deviations as core frames to create thumbnails.

### PRIORITY

This application claims priority under 35 U.S.C. § 119 to an application filed in the Korean Intellectual Property Office on Dec. 1, 2005 and assigned Serial No. 2005-116133, the contents of which are incorporated herein by reference.

### BACKGROUND OF THE INVENTION

1. Field of the Invention

The present invention relates generally to a method and apparatus of creating and displaying a thumbnail, and in particular, to a method and apparatus of creating an animated thumbnail at a reduced cost using only luminance of each frame of a video sequence in a mobile communication terminal.

2. Description of the Related Art

With the development of multimedia technologies, the use of digital multimedia information is greatly increasing. Moreover, as recent mobile communication systems allow transmission of large-capacity data at a high rate, mass visual contents such as video data are being increasingly used in the mobile communication terminal. Therefore, research is ongoing on a method of facilitating search or management of the multimedia information.

A “thumbnail” refers to a small image obtained by extracting a core frame of original data having a relatively large size in order to facilitate search or management of the multimedia information.

The most commonly used techniques that extract a core frame for creating the thumbnail according to the conventional art include a technique that selects a first frame of each video shot as a core frame, and a technique that selects a core frame based on a frame quality factor.

In the technique that selects a core frame according to the frame quality factor, the frame quality factor is represented by a weighted combination of an entropy and a standard deviation of color histograms, and a frame having the highest frame quality factor is selected as a core frame. That is, the core frame is selected by the use and analysis of visual criteria such as color properties of the video shot and a motion between video frames.

The technique that selects the first frame as the core frame requires a low cost of calculation, but has problems in that conspicuous video contents of the video shot cannot be effectively captured. In contrast, the technique that selects the core frame according to the frame QoS can effectively capture visual contents because it takes the color properties of the video shot and the motion between the video frames into account, but disadvantageously requires a high cost of calculation.

### SUMMARY OF THE INVENTION

An object of the present invention is to substantially solve at least the above problems and/or disadvantages and to provide at least the advantages below. Accordingly, an object of the present invention is to provide a method and apparatus of creating and displaying a thumbnail, which reduces a thumbnail creation cost and captures conspicuous visual contents by taking the luminance of each frame of a video sequence into account.

Another object of the present invention is to provide a method and apparatus of creating and displaying an animated thumbnail in consideration of only the luminance of each frame of a video sequence.

According to an aspect of the present invention, a method and apparatus of creating and displaying an animated thumbnail includes creating an animated thumbnail using luminance of basic frames of a video sequence; creating a thumbnail list using the created thumbnails; and when one thumbnail is selected from the thumbnail list, displaying an animated video thumbnail of the selected thumbnail.

According to another aspect of the present invention, a method of creating a thumbnail by using luminance of a video sequence includes grouping the video sequence into predetermined frame groups and extracting basic frames of the groups; calculating luminance a difference between the extracted basic frames using the extracted basic frames; selecting motion prediction pixel frames using the calculated luminance differences between the basic frames; and calculating standard deviations of the selected motion prediction pixel frames and selecting a predetermined number of frames having great standard deviations as core frames to create thumbnails.

### BRIEF DESCRIPTION OF THE DRAWINGS

The above and other objects, features, and advantages of the present invention will become more apparent from the following detailed description when taken in conjunction with the accompanying drawings in which:

FIG. 1 is a block diagram of a mobile communication terminal for generating a thumbnail according to the present invention;

FIG. 2 is a flowchart showing a process of displaying an animated thumbnail in a mobile communication terminal according to the present invention;

FIG. 3 is a flowchart showing a process of generating an animated thumbnail in a mobile communication terminal according to the present invention; and

FIG. 4 is a view illustrating a screen displaying a list of thumbnails in 3×3 configuration.

### DETAILED DESCRIPTION OF THE PREFERRED EMBODIMENTS

Preferred embodiments of the present invention will be described herein below with reference to the accompanying drawings. In the following description, well-known functions or constructions are not described in detail because they would obscure the present invention in unnecessary detail.

A technique will be described below, which reduces a thumbnail creation cost by using the luminance of each frame of a video sequence, and creates a thumbnail by capturing conspicuous visual contents. Even though creating and displaying a thumbnail in a mobile communication terminal are described, the present invention is not limited thereto and may be applied to various fields that creates and displays the thumbnail.

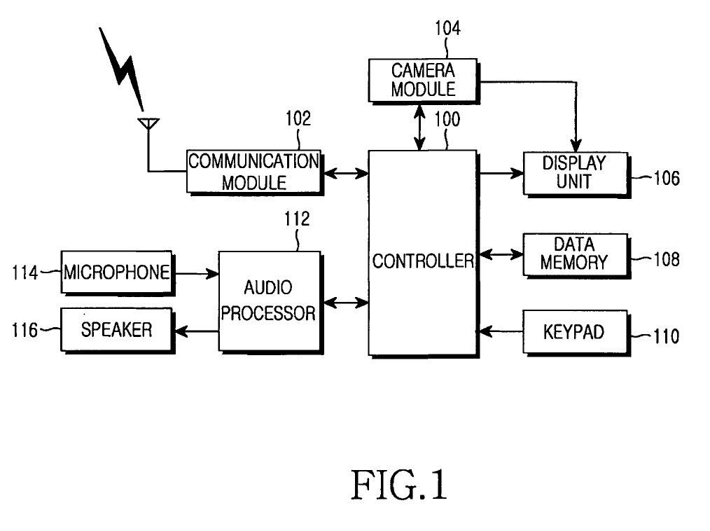

FIG. 1 is a block diagram of a mobile communication terminal according to the present invention. Examples of the mobile communication terminal may include cellular phones, Personal Communication System (PCS) terminals, Personal Data Assistants (PDAs), International Mobile Telecommunications-2000 (IMT-200) terminals, or the like. The following description will be made with a general structure of those examples.

Referring to FIG. 1, a controller (e.g., a microprocessor unit (MPU)) 100 controls an overall operation of the mobile communication terminal. For example, the controller 100 processes and controls voice communication and data communication. In addition to the general functions, the controller 100 serves to create and display an animated thumbnail of a video sequence using luminance according to the present invention. The general functions of the controller 100 will be omitted for conciseness.

A communication module 102 processes a radio data signal received/transmitted through an antenna. For example, during a transmission operation, the communication module 102 channel-codes and spreads transmission (TX) data to output an RF signal. During a reception operation, the communication module 102 converts a received RF signal into a baseband signal and recovers a data by despreading and channel-decoding the baseband signal.

A camera module 104 includes an image sensor, a camera lens, a signal processor, and an image processor. The camera module 104 converts captured image data into digital data to obtain a moving image or a still image, and then outputs the moving or still image to a display unit 106.

The display unit 106 displays status information generated during operations of the mobile communication terminal, numerals and characters, moving images and still images under control of the controller 100. A color liquid crystal display (LCD) may be used for the display unit 106.

A memory unit 108 includes a read only memory (ROM), a random access memory (RAM), and a flash ROM. The ROM stores microcodes of a program and various reference data for processing and controlling the controller 100. Particularly, the ROM stores a program for creating and displaying an animated thumbnail using luminance of a video sequence according to the present invention. The RAM is a working memory of the controller 100, which stores temporary data generated during operations. Also, the flash ROM stores various updateable data such as a phone book, outgoing messages, incoming messages, or the like. Also, the flash ROM stores an animated thumbnail of each video sequence generated by the thumbnail creating program.

A keypad 110 includes numeric keys of digits 0-9 and a plurality of function keys, such as a Menu key, a Cancel (Delete) key, a Confirmation key, a Talk key, an End key, an Internet connection key, and Navigation keys (▴/▾/ [symbol] / [symbol] ) to provide key input data that corresponds to keys pressed by a user to the controller 100.

An audio processor 112 is called a CODEC and inputs and outputs an audio signal through a microphone 114 and a speaker 116. For example, the audio processor 112 converts digital data received from the controller 100 into analog audio signals to output the analog audio signals through the speaker 116, and converts audio signals received through the microphone 114 into digital data to output the digital data to the controller 100.

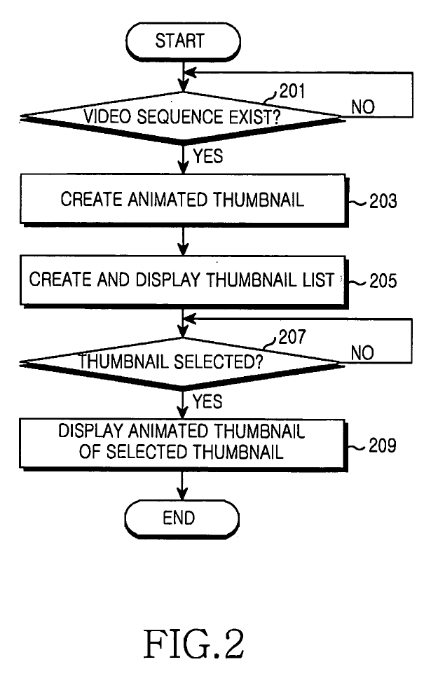

FIG. 2 is a flowchart showing a process of creating an animated thumbnail in a mobile communication terminal according to the present invention.

Referring to FIG. 2, the controller 100 searches a video sequence existing in the mobile communication terminal in step 201. The video sequence may be captured through the camera module of the mobile communication terminal, or may be received from the outside through an interface connection or communication module.

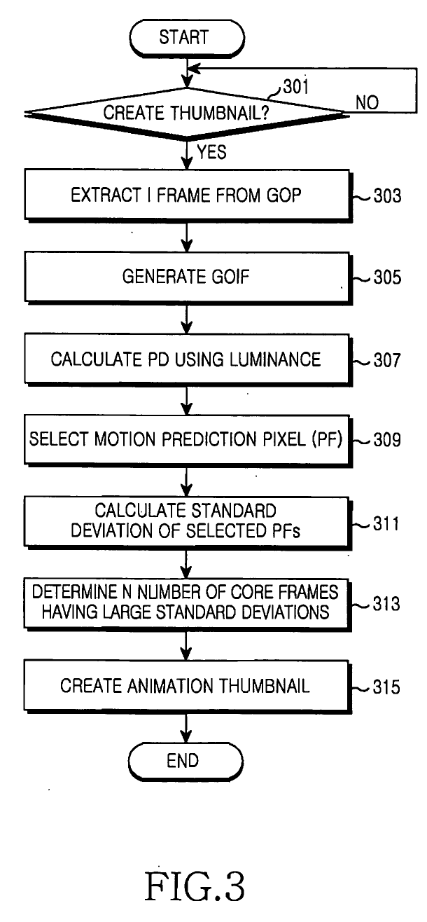

When the video sequence is searched in step 201, the controller 100 creates animated video thumbnails using luminance of each frame of the searched video sequence in step 203, which will be described later in further detail with reference to FIG. 3.

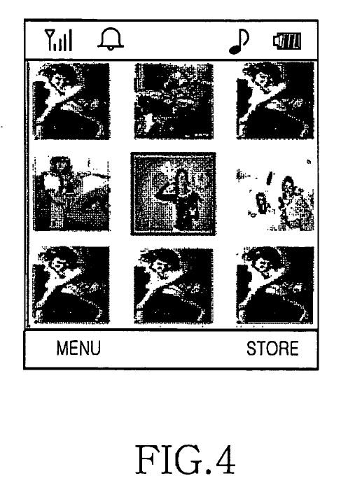

When the video thumbnails are created in step 203, as illustrated in FIG. 4, the controller 100 creates a thumbnail list (e.g., 3×3 thumbnail list) using the created thumbnails, and displays the list on the display unit 106 in step 205. The thumbnails included in the displayed thumbnail list display first frames of images, respectively.

In step 207, the controller 100 checks whether one thumbnail from the displayed thumbnail list is selected by a user's key manipulation.

When one thumbnail is selected, the controller 100 displays animation thumbnail information of the selected thumbnail in step 209. Other thumbnails that are not selected display the first frames of the images, respectively.

Thereafter, the controller 100 terminates the algorithm.

FIG. 3 is a flowchart of a process of creating an animated thumbnail in the mobile communication terminal according to the present invention.

Referring to FIG. 3, the controller 100 checks whether a thumbnail creating mode is performed in step 301. That is, the controller 100 checks whether a new video sequence is input to the mobile communication terminal and thumbnails of the video sequence are created.

When the thumbnail creating mode is performed, the controller 100 groups the entire input video sequence into groups of pictures (GOPs) by a predetermined number of frames, and then extracts I frames, a reference frame, from the GOPs in step 303. The “I frame” refers to a random access point to allow desired contents to be easily checked from the GOPs.

After the I frame is extracted from the GOP, the controller 100 creates a group of I frames (GOIF), a stream combination of the I frames extracted from the individual GOPs in step 305.

In step 307, the controller 100 calculates a picture difference (hereinafter, referred to as PD) between matching pixels of a previous I frame and a current I frame with respect every pixel of each frame using Equation (1):

$$PD ( x , y ) = {\sum }_{i = 0}^{M} {\sum }_{j = 0}^{N} {F}_{pre} ( x + i , y + j ) - {F}_{current} ( x + i , y + j ) , 0 \leq x < M , 0 \leq y < N \qquad ( 1 )$$

where x and y denotes locations of a pixel, and M and N denote horizontal and vertical resolutions, respectively. For example, in the case of a common intermediate format (CIF), M is 288 and N is 360. In the case of quarter CIF (QCIF), M is 144 and N is 180.

To reduce computation quantity, only a luminance (Y) value of a YUV image format is used when the PDs are calculated using Equation (1). Because human eyes are insensitive to changes in a chrominance information value of an adjacent pixel rather than luminance changes, only the use of the luminance may contribute to find a visually conspicuous core frame. The YUV is aimed at the fact that the human eyes are sensitive to luminance rather than chrominance, in which the color is divided into a Y component, the luminance, and U and V components, the chrominance.

In step 309, after the PD of each I frame is calculated, the controller 100 selects a motion prediction pixel (PF) frame using Equation (2):

$${PF}_{n} = [ {\sum }_{i = 0}^{M} {\sum }_{j = 0}^{N} {PD}_{pre} ( x + i , y + j ) - {PD}_{current} ( x + i , y + j ) ] > T \qquad ( 2 )$$

where x and y denotes locations of a pixel, M and N is horizontal and vertical resolutions, and n denotes a location of an I frame set as the PF frame.

When a difference between the previous PD and the current PD obtained using Equation (2) is greater than a critical value (T), the corresponding I frame is selected as a PF frame.

After the PF frames are selected in such a manner, the controller 100 calculates standard deviations of the selected PF frames in step 311. In step 313, the controller 100 determines, as core frames, P number of frames having relatively large standard deviations of the calculated standard deviations of the selected PF frames.

In step 315, the controller 100 creates an animated thumbnail using the P number of core frames and then terminates the algorithm.

According to the present invention, an animated thumbnail is created using only luminance of a video sequence. Because only a luminance (Y) value of the YUV image format is used, a thumbnail can be created by capturing conspicuous visual contents at a creation cost reduced by ⅓. Also, the animated thumbnail allows for convenient searching for a video file.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A method of creating a thumbnail using luminance of a video sequence, the method comprising the steps of:
grouping the video sequence into predetermined frame groups and extracting basic frames of the groups;
calculating a luminance difference between the extracted basic frames using the extracted basic frames;
selecting motion prediction pixel frames using the calculated luminance difference between the basic frames; and
calculating standard deviations of the selected motion prediction pixel frames and selecting a predetermined number of frames having large standard deviations as core frames to create thumbnails.

2. The method of claim 1, wherein the luminance difference between the basic frames is calculated by comparing a luminance value of each pixel of a previous basic frame to a luminance value of each pixel of a current basic frame.

3. The method of claim 1, wherein the luminance difference between the basic frames is calculated using:
$$PD ( x , y ) = {\sum }_{i = 0}^{M} {\sum }_{j = 0}^{N} {F}_{pre} ( x + i , y + j ) - {F}_{current} ( x + i , y + j ) , 0 \leq x < M , 0 \leq y < N$$
where x and y are locations of a pixel, M and N are horizontal and vertical resolutions, Fₚᵣₑ is a previous frame, and F_{current} is a current frame.

4. The method of claim 1, wherein the motion prediction pixel frame is selected as a frame of the extracted basic frames, which has a luminance difference from a previous basic frame greater than a predetermined reference value.

5. The method of claim 1, wherein the motion prediction pixel frame is calculated using:
$${PF}_{n} = [ {\sum }_{i = 0}^{M} {\sum }_{j = 0}^{N} {PD}_{pre} ( x + i , y + j ) - {PD}_{current} ( x + i , y + j ) ] > T$$
wherein x and y are locations of a pixel, M and N are horizontal and vertical resolutions, n is a location of an I frame selected as a motion prediction pixel frame, and T is a critical value.

6. The method of claim 1, wherein the creating of the thumbnail includes consecutively displaying a predetermined number of selected core frames to obtain an animation effect.

7. A method of creating and displaying an animated thumbnail, the method comprising the steps of:
creating an animated thumbnail using luminance of basic frames of a video sequence;
creating a thumbnail list using the created thumbnails; and
when one thumbnail is selected from the thumbnail list, displaying an animated video thumbnail of the selected thumbnail.

8. The method of claim 7, wherein the step of creating the animated thumbnail comprises:
calculating luminance differences between basic frames of the video sequence;
selecting motion prediction pixel frames using the calculated luminance differences; and
calculating standard deviations of the selected motion prediction pixel frames and selecting a predetermined number of frames having relatively large standard deviations as core frames.

9. The method of claim 7, wherein the step of creating the animated thumbnail comprises consecutively displaying the predetermined number of selected core frames to obtain an animation effect.

10. The method of claim 7, further comprising displaying images of first frames of the thumbnails not selected from the thumbnail list.

11. A method of creating a thumbnail using luminance of a video sequence, the method comprising the steps of:
calculating a luminance difference between the frames of the video sequence;
selecting motion prediction pixel frames using the calculated luminance difference between the basic frames; and
calculating standard deviations of the selected motion prediction pixel frames and selecting a predetermined number of frames having large standard deviations as core frames to create thumbnails.

12. A mobile communication terminal for creating a thumbnail using luminance of a video sequence, the terminal comprising:
a controller for grouping the video sequence into predetermined frame groups and extracting basic frames of the groups, calculating a luminance difference between the extracted basic frames using the extracted basic frames, selecting motion prediction pixel frames using the calculated luminance difference between the basic frames and calculating standard deviations of the selected motion prediction pixel frames and selecting a predetermined number of frames having large standard deviations as core frames to create thumbnails; and
a display unit for displaying the thumbnails.

13. The mobile communication terminal of claim 12, wherein the luminance difference between the basic frames is calculated by comparing a luminance value of each pixel of a previous basic frame to a luminance value of each pixel of a current basic frame.

14. The mobile communication terminal of claim 12, wherein the luminance difference between the basic frames is calculated using:
$$PD ( x , y ) = {\sum }_{i = 0}^{M} {\sum }_{j = 0}^{N} {F}_{pre} ( x + i , y + j ) - {F}_{current} ( x + i , y + j ) , 0 \leq x < M , 0 \leq y < N$$
where x and y are locations of a pixel, M and N are horizontal and vertical resolutions, Fₚᵣₑ is a previous frame, and F_{current} is a current frame.

15. The mobile communication terminal of claim 12, wherein the motion prediction pixel frame is selected as a frame of the extracted basic frames, which has a luminance difference from a previous basic frame greater than a predetermined reference value.

16. The mobile communication terminal of claim 12, wherein the motion prediction pixel frame is calculated using:
$${PF}_{n} = [ {\sum }_{i = 0}^{M} {\sum }_{j = 0}^{N} {PD}_{pre} ( x + i , y + j ) - {PD}_{current} ( x + i , y + j ) ] > T$$
wherein x and y are locations of a pixel, M and N are horizontal and vertical resolutions, n is a location of an I frame selected as a motion prediction pixel frame, and T is a critical value.

17. The mobile communication terminal of claim 12, wherein the creating of the thumbnail includes consecutively displaying a predetermined number of selected core frames to obtain an animation effect.

18. A mobile communication terminal for creating and displaying an animated thumbnail, the terminal comprising:
a controller for creating an animated thumbnail using luminance of basic frames of a video sequence, creating a thumbnail list using the created thumbnails, and when one thumbnail is selected from the thumbnail list, displaying an animated video thumbnail of the selected thumbnail; and
a display unit for displaying the thumbnail.

19. The mobile communication terminal of claim 18, wherein the controller performs, in the step of creating the animated thumbnail, calculating luminance differences between basic frames of the video sequence, selecting motion prediction pixel frames using the calculated luminance differences, and calculating standard deviations of the selected motion prediction pixel frames and selecting a predetermined number of frames having relatively large standard deviations as core frames.

20. A mobile communication terminal for creating a thumbnail using luminance of a video sequence, the terminal comprising:
a controller for calculating a luminance difference between the frames of the video sequence, selecting motion prediction pixel frames using the calculated luminance difference between the basic frames, and calculating standard deviations of the selected motion prediction pixel frames and selecting a predetermined number of frames having large standard deviations as core frames to create thumbnails; and
a display unit for displaying the thumbnails.
